(19) United States
(12) Patent Application Publication
(10) Pub. No.: US 2012/0090410 A1
(43) Pub. Date: Apr. 19, 2012

(54) Method for aflatoxin screening of products

(76) Inventor: Mansour Samadpour, Lake Forest Park, WA (US)

(21) Appl. No.: 12/925,369

(22) Filed: Oct. 19, 2010

(51) Int. Cl. G01N 1/04

(52) U.S. Cl. 73/863

(57) ABSTRACT

A method for screening a lot of product comprising multiple, individual bags or bins wherein a samples taken from each bag or bin are formed into a composite, which composite is tested for toxin or other contamination. If the test shows positive, the samples are then tested individually to determine which bag or bin is contaminated, thus permitting non-contaminated bags or bins to be released.

The present invention relates to a method for avoiding waste of food and other products related to a positive test for the presence of aflatoxin and similar toxins.

Currently, testing for microbial toxins such as aflatoxin and other mycotoxins is conducted in a manner that results in rejection of the entire lot of the product. For instance pistachio and almond aflatoxin testing relies on collecting 5-10 kg of sample from 20-22 bins/bags of products, each containing about 2000 pounds of the product. The sample is then homogenized/blended and a small portion (150 grams) is subjected to ethanol extraction followed by cleanup and detection. Under the prior art, if the sample tests positive, all 20-22 bins/bags are typically destroyed, with economic loss to the producers.

In the current invention each bin/bag is sampled individually, each sample is blended/homogenized individually, and a composite consisting of preferably equal volumes taken from each sample homogenate/blend is formed and subjected to the detection protocol. If the result is acceptable, then the entire group of bins/bags is accepted. However, if the levels of the toxin are higher than the accepted standards, then each bin/bag homogenate is tested separately, and any bin/bag for which the corresponding homogenate has a higher than acceptable limit is then excluded. A new composite is formed from bags/bins that have below acceptable limit levels of the toxin. and tested to issue a certificate of analysis. Alternatively, bags that have a mean average of toxin level falling below the acceptable limit for the lot can be used to form a composite and an additional test performed to verify the level of toxin in this composite. Alternatively the final composite may not need to be formed and tested. Instead an arithmetic mean of the bags that have suitable levels of toxins can be calculated to estimate a final level and issue a certificate based on individual bag/bin/test results.

In the following, “aflatoxin” is used as an exemplary toxin which may be deal with using the disclosed process. However, the process may just as well be used with other mycotoxins or other forms of contamination as needs dictate.

### BRIEF DESCRIPTION OF THE DRAWING

FIG. 1 is a flow diagram of the method disclosed herein.

### DETAILED DESCRIPTION

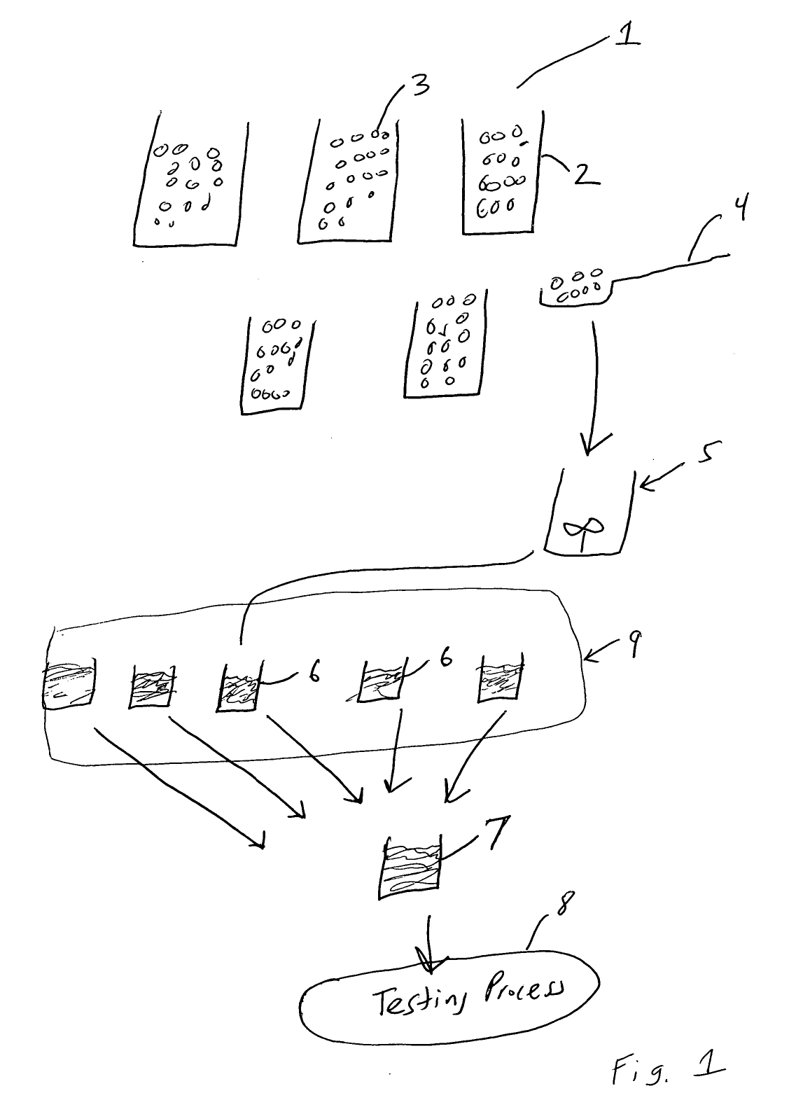

FIG. 1 shows test lot 1, which is a collection of bins 2 containing product 3, which may be food product such as nuts, including pistachios or almonds. Sampling device 4 is used to take a sample of product from each bin, each sample is homogenized by blending device 5, and placed in individual sample containers 6. A portion of the contents of each container 6 is then taken and placed in composite sample container 7. The contents of 7 are well mixed and subjected to aflatoxin testing process 8. Meanwhile, each container 6 and its remaining contents are stored in holding area 9. If the results of testing process 8 show aflatoxin at acceptable levels, then the entire test lot of bins is released for delivery to the customer. If results of testing process 8 show aflatoxin above acceptable limits in the test lot, then individual containers in holding area 9, each containing sample from a single bin 2, are tested to determine the level of aflatoxin present in individual bins 2. If a particular bin 2 is thus identified to have an above-acceptable level of aflatoxin, that bin is excluded from shipment. Meanwhile, the remaining bins may be assembled into a lot that may be released to the customer, and a certificate of compliance with aflatoxin standards for the lot may be based upon the mathematically averaged results of the previous individual tests or upon additional testing of a composite formed from taking samples from such of the individual samples 6 as tested at acceptable levels.

I claim:

1. A method for screening a test lot of product, which lot is comprised of a plurality containers such as bins or bags or the like, which method comprises the steps of:
a) taking at least one sample from each container;
b) taking a portion of each sample and combining these portions into a composite;
c) testing said composite for contamination;
d) in the event the testing of step c) indicates contamination, retesting the samples taken in step a) to determine the level of contamination in each container.
